(19) United States
(12) Patent Application Publication
(10) Pub. No.: US 2013/0166594 A1
(43) Pub. Date: Jun. 27, 2013

(54) Advertisement, Feature and Data Provisioning Based on Dialed Numbers and Other Addresses

(71) Applicant: T-Mobile USA, Inc., Bellevue, WA (US)

(72) Inventors: Michael Steffen Vance, Kenmore, WA (US); Michael Thomas Hendrick, Renton, WA (US); Richard W. Hansen, Seattle, WA (US)

(73) Assignee: T-Mobile USA Inc., Bellevue, WA (US)

(21) Appl. No.: 13/724,573

(22) Filed: Dec. 21, 2012

Related U.S. Application Data
(60) Provisional application No. 61/580,079, filed on Dec. 23, 2011.

(51) Int. Cl. G06F 17/30

(52) U.S. Cl. CPC G06F 17/30424
USPC 707/772

(57) ABSTRACT

Telecommunication devices described herein are configured to display media, such as advertisements or coupons or options to perform actions, responsive to associations between the media and addresses, such as phone numbers, inputted on the devices.

### RELATED APPLICATIONS

This application claims priority to U.S. provisional patent application No. 61/580,079, entitled “Advertisement and Feature Provisioning Based on Dialed Numbers” and filed on Dec. 23, 2011. Application No. 61/580,079 is fully incorporated herein by this reference.

### BACKGROUND

Search engines typically provide both sought-after and sponsored search results in answer to queries. Users of search engines can obtain such results by typing a search query, usually consisting of a word or words, but also potentially consisting of numbers, into the search engine and then pressing “Enter,” a soft key, or some other dedicated button for initiating the search. The search engine then processes the search query based on a variety of criteria. Sought-after search results tend to be non-commercial in nature and are usually ordered based upon the search engine algorithm's ranking of most relevant search results for the user. Sponsored results, however, are usually commercial in nature and may be determined by a keyword bidding process in which competing businesses, enterprises and organizations indicate advertising priorities and budgets and the search engine selects search results associated with ones of these businesses to provide in answer to queries. Users may access these search results through browsers on any of a variety of devices, such as desktop computers, laptop computers, tablet computers, or telecommunication devices.

The ability to present users with advertisements related to their interests has also been significantly expanded by social networks and discount services, such as GroupOn™. Social networks and discount services track user behavior and provide advertisements and coupons based on this behavior. Thus, users are offered a wide range of interesting content based on active expressions of interest, such as querying search engines, and passive expressions, such as behavioral histories.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 illustrates an example environment including a telecommunication device configured to display advertisements, features and data associated with dialed numbers and other addresses, in accordance with various embodiments.

FIG. 2A illustrates a telecommunications device.

FIGS. 2B-2H illustrate user interfaces of a telecommunication device performing the techniques described herein, in accordance with various embodiments.

FIG. 3 illustrates a flowchart showing an example method of determining media associated with an inputted address based at least in part on information associated with that address stored on the telecommunication device and of displaying that media, in accordance with various embodiments.

FIG. 4 illustrates a flowchart showing an example method of determining media associated with an inputted address based at least in part on information associated with that address, that information being retrieved from a remote identification server, and of displaying that media, in accordance with various embodiments.

FIG. 5 illustrates a flowchart showing an example method of presenting pre-loaded media associated with an inputted number or address, in accordance with various embodiments.

FIG. 6 illustrates an example computing device system architecture, in accordance with various embodiments.

### DETAILED DESCRIPTION

Described herein are techniques for presenting media, such as advertisements, coupons, applications, options to perform actions, such as launching or downloading applications, and other information, responsive to associations between addresses, such as phone numbers, e-mail addresses, social networking handles, etc., and the media. In response to a user inputting an address, the telecommunications device may evaluate and determine whether the address maps to an address stored in a data store, such as a contact list, communication list or other data store. If the address maps to such stored address, then the telecommunications device presents the associated media on the telecommunications device or, if the media is not stored on the telecommunications device, then the telecommunications device obtains such media from a remote source, such as an advertisement server or application server, and then presents it to the user. If the media is an advertisement or coupon, then the media is presented on the telecommunications device. If the media is a downloaded or downloadable application, then the telecommunications device launches such application or presents the option to download or launch the application. If the address is associated with media involving an action, such as media offering the user the option of calling a phone number or launching a website, the telecommunications device presents such an offer to the user. If the address is associated with other information, such as media residing on the telecommunications device or media stored remotely from the telecommunication device, the telecommunications device presents that information on the telecommunications device. If the inputted address fails to map to an address stored in the telecommunications device, then the telecommunication device provides the address to an identification server and receives identification information from the identification server. The telecommunication device then evaluates the received identification information to determine whether the inputted address maps to a record in the received information and, if it does, then provides some or all of the information received from the identification server to an advertisement server or application server. In response, the telecommunication device receives media from that server and presents the received media.

### Example Environment

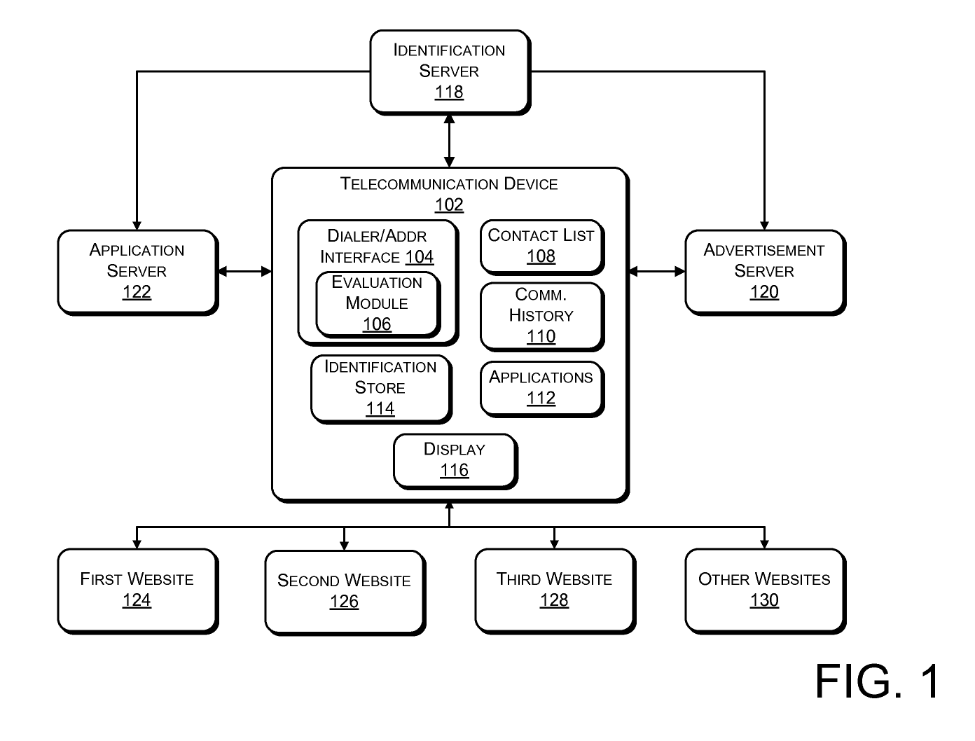

FIG. 1 illustrates an example environment including a telecommunication device configured to display media associated with inputted addresses, in accordance with various embodiments. As illustrated, a telecommunication device 102 may be any type of device with telecommunications capabilities, such as a cellular phone, a smart phone, a tablet computer, a netbook, a laptop computer, a desktop computer, a television, a media player, etc. Telecommunication device 102 may be configured with multiple components 104-116 enabling the telecommunication device 102 to evaluate inputted addresses, such as phone numbers, e-mail addresses, social networking names, or “handles” and other addresses, and then present media associated with such inputted addresses, such as advertisements and/or coupons, feature offerings or other data.

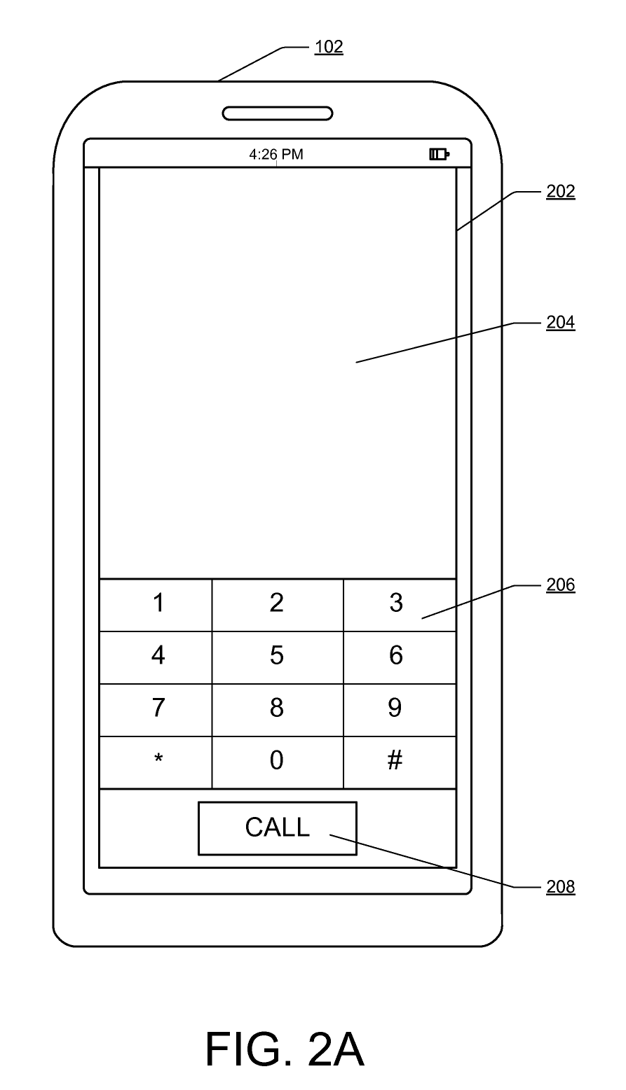

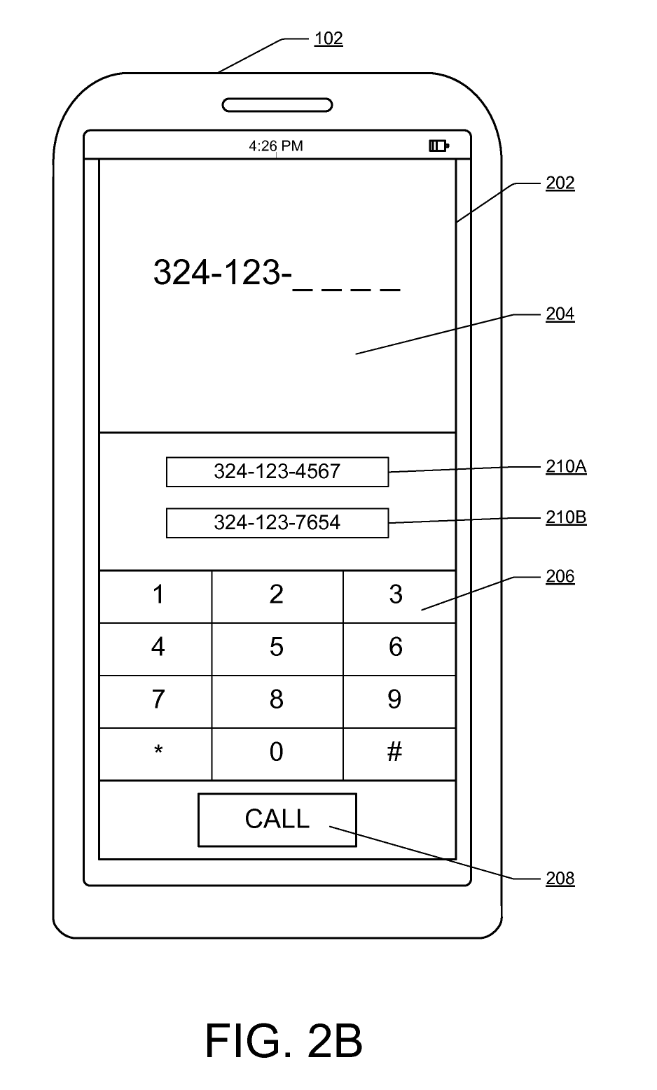

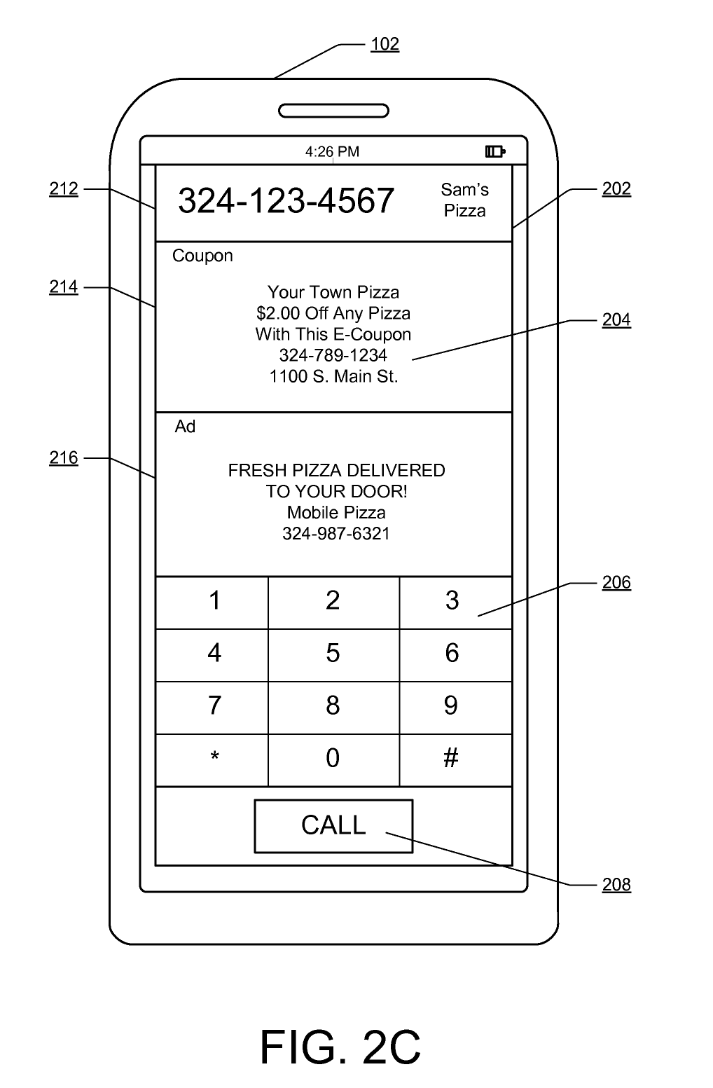

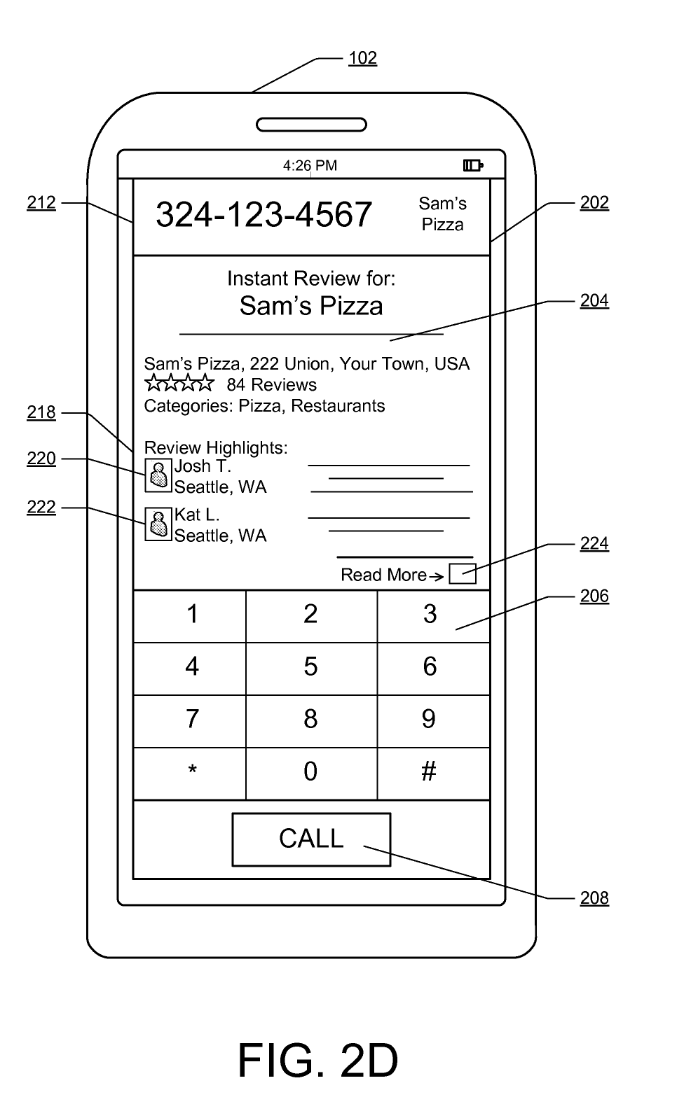

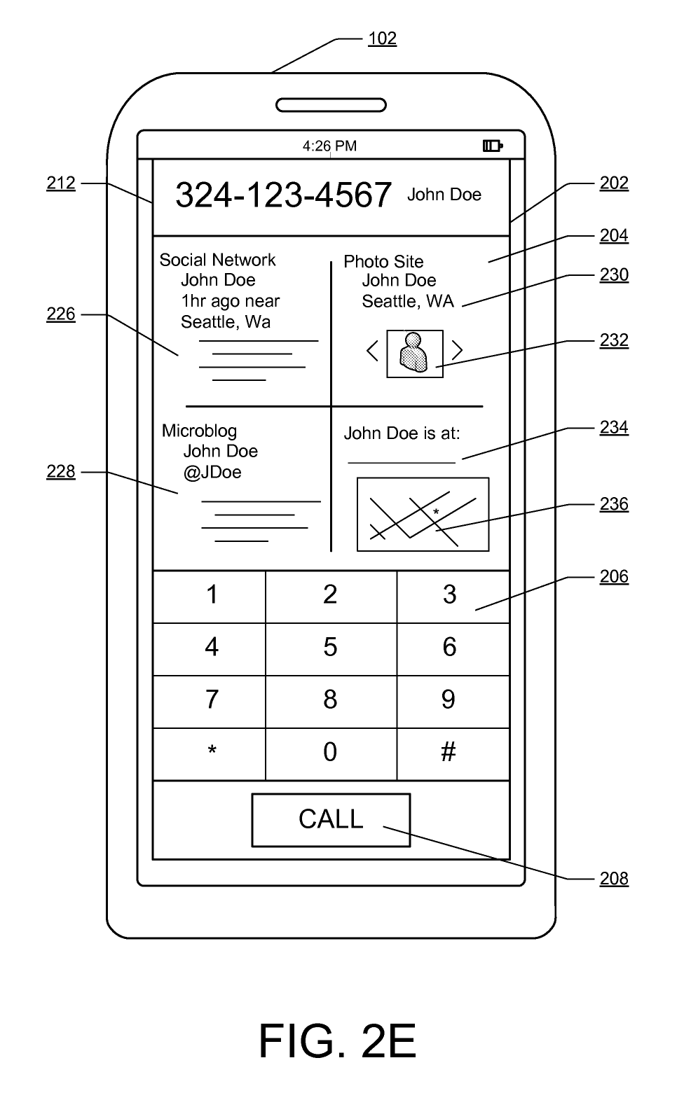

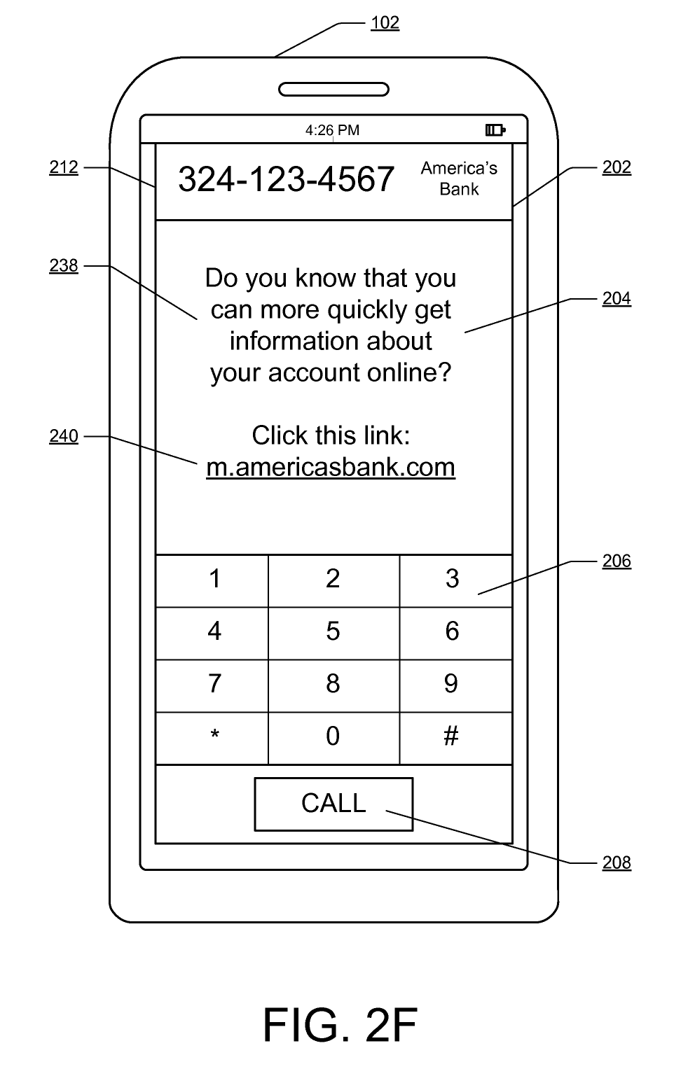

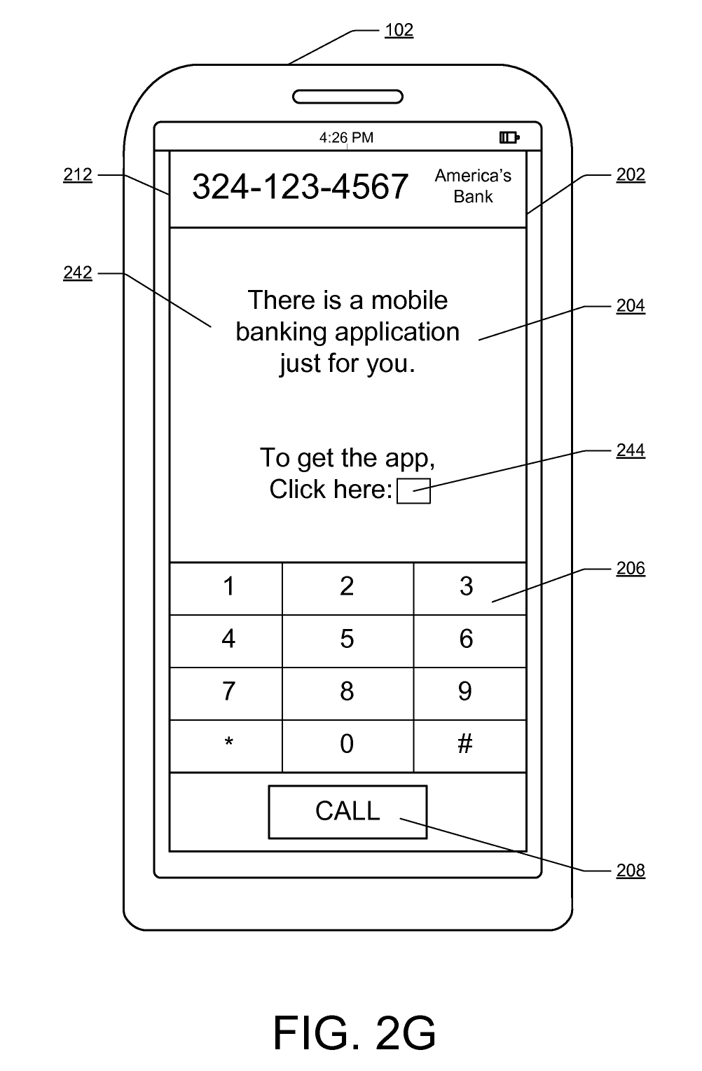

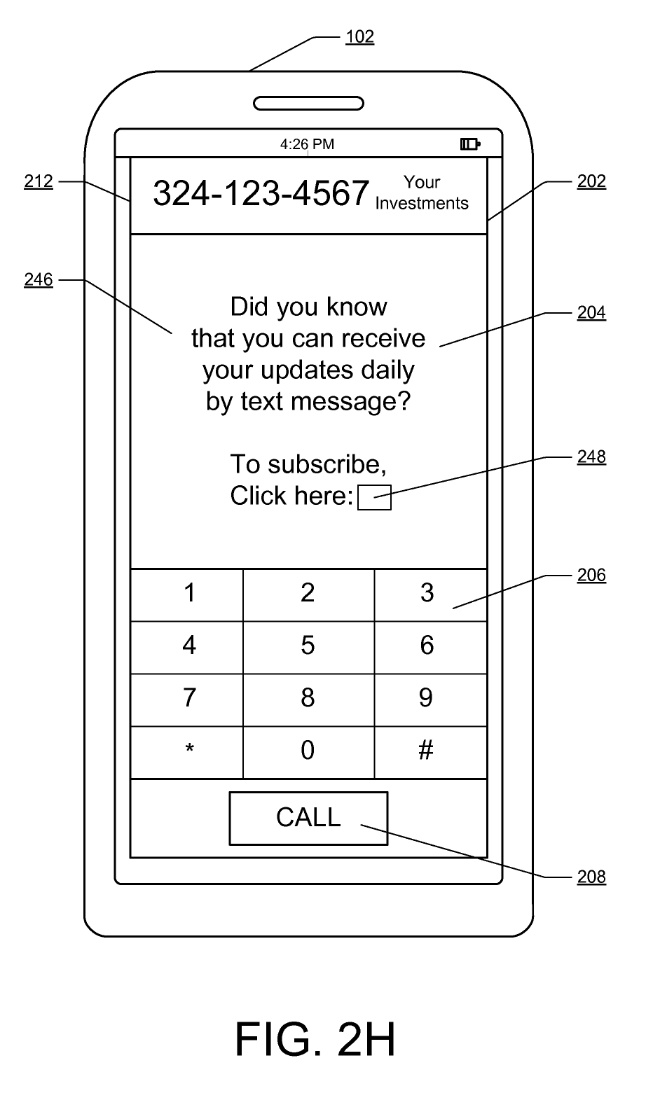

These components 104-116 include a dialer/addressing interface 104 that may be any type of dialing or addressing interface capable of receiving inputted data that is used to dial a phone number or address another communication, such as an e-mail, text message, multimedia message, social networking handle, etc. As illustrated in FIGS. 2A-2H, the dialer/addressing interface 104 may be associated with a graphic user interface (GUI) for dialing telephone numbers through a touch screen display of a telecommunications device 102. It will be understood that many other types of dialer/addressing interfaces are contemplated herein, such as e-mail interfaces, text messaging interfaces, multimedia messaging interfaces, social networking interfaces, etc., all of which include at least an address field for addressing of the communication. It will additionally be understood that dialer/addressing interface 104 may accept data input in any manner, such as by a user tapping hard or soft keys, speaking into a speech recognition interface, etc.

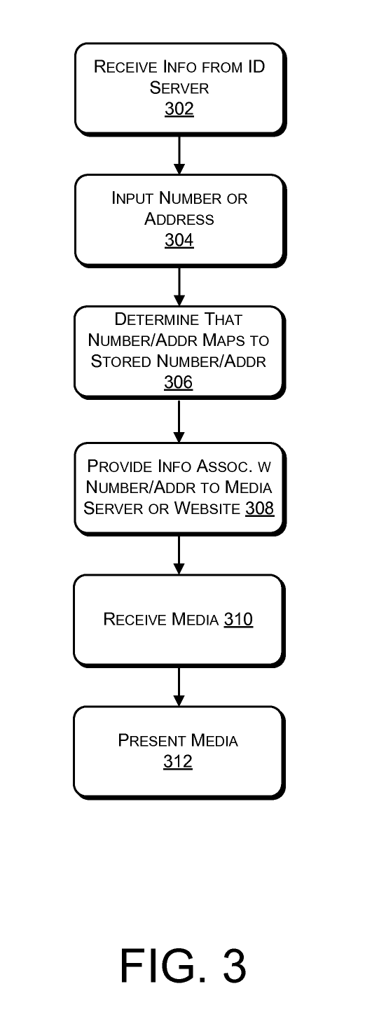

The dialer/addressing interface 104 includes or accesses an evaluation module 106. Evaluation module 106 evaluates user-inputted addresses to determine whether such addresses map to other addresses, thereby triggering the presentation of media as described herein. In an embodiment, the evaluation module 106 may evaluate data as it is being input in order to predict the final inputted data. For example, the evaluation module 106 may poll a contact list 108, communication history 110, identification store 114, or other stores, as data is being input and, if the portion of received data maps to data in the contact list, then the evaluation module 106 may cause the dialer/addressing interface 104 to present one or more predicted addresses, which the user of telecommunications device 102 may then select in order to quickly complete the data input. In an embodiment, evaluation module 106 may poll other data stores residing on telecommunications device 102 or that are stored remotely from telecommunications devices 102, such as identification server 118. In an embodiment, if a portion or all of the received data maps to data in identification store 114, then telecommunications device 102 will present media that is associated with such address as described herein. In an embodiment, evaluation unit 106 may poll identification server 118 and, if a portion or all of the received data maps to data in identification server 118, then telecommunications device 102 will present media that is associated with such address as described herein. The operations of the evaluation module 106 are shown in FIGS. 3-5 and are described below in further detail with reference to those figures.

Contact list 108 is a data store for information associated with the user's contacts, and may contain the contact's names, physical addresses, phone numbers, e-mail addresses, social networking handles, and other information. Communications history 110 is a data store for information associated with specific communications that have been engaged in by telecommunications device 102, such as phone calls, video chat sessions, e-mails, text messages, multimedia messages, etc., and may include communicants' names, physical addresses, phone numbers, e-mail addresses, social networking handles, etc. Although presented as residing on telecommunications device 102, one of skill in the art will recognize that any or all of contact list 108 and communications history 110 may alternatively or additionally reside external to telecommunications device 102 but nonetheless be accessible to telecommunications device 102 by virtue of direct connection (such as flash memory connected to telecommunications device 102 via a USB port) or network connection (such as cloud services). In an embodiment, the contact list 108 and communication history 110 may be updated with identification information received from the identification server 118, and may be polled by evaluation module 106 while or after a number or address is being or has been inputted into dialer/addressing interface 104.

Applications 112 are any type of executable applications that reside on telecommunications device 102. Applications may include any type of downloadable application that telecommunications device 102 may obtain from a remote server, such as an application store such as the Apple® AppStore or Google® Play. Applications 112 may include metadata of applications, such as phone numbers and other addresses, zip codes, names, locations, and categories of interest. Applications 112 may further include identifications of applications to offer to users as being available for download in response to dialing certain numbers. These identifications may also have metadata including phone numbers and other addresses, zip codes, names, locations, and categories of interest.

Identification store 114 includes data that is or has been provided to telecommunications device 102 from identification server 118. Identification server 118 may be situated within a telecommunications carrier's network or it may be accessible via the Internet. In an embodiment, identification store 114 may be configured to fully purge all data stored therein upon the receipt of a new data set from identification server 118. In an embodiment, identification store 114 may purge some of the data records stored therein dependent upon metadata associated with such records, such as a retailer's hours of operation, time restrictions regarding when a particular advertising offer is available, etc.

Display 116 is any type of display that may be sensed by the user of telecommunications device 102. Display 116 is typically a visual display, such as an LED display or a touch screen display, but may also include audio speakers, tactile displays or any other type of display.

Identification server 118 is communicative with telecommunications device 102 in any manner and may provide periodically or randomly, and either on a push or pull basis, phone numbers and/or other addresses which relate to advertisements, features and/or other data. Upon receiving this information from the identification server 118, the telecommunication device may store the information in its identification store 114. Identification server 118 may be part of a telecommunications carrier's network or may be independent of that carrier's network (e.g., accessible via the Internet).

In some embodiments, identification server 118 includes a data store in which addresses are associated with media. These addresses may be any type of address or identifier that are sufficient for the initiation or addressing of any type of communication, such as phone numbers, e-mail addresses, text messaging addresses, social networking handles, IM handles, etc. The media may be any type of media capable of being presented on or via telecommunications device 102, such as advertisements, coupons, offers, software applications, information, data, photographs, images, blog postings, etc. The media may reside on another server, such as an advertisement server 120, an application server 122, or any other server including servers hosting or used by websites, such as first website 124 (e.g., Yelp.com), second website 126 (e.g., Facebook.com), third website 128 (e.g., Flickr.com), or other websites 130. In embodiments where media is stored on another server, then identification server 118 stores information sufficient to permit it or telecommunications device 102 to receive, view, or otherwise navigate to such media. For example, identification server 118 may associate phone numbers with advertisements or coupons stored on advertisement server 120. Such a number may be, for instance, the phone number for a pizza restaurant, which is associated with a coupon from a competing pizza restaurant that is stored on advertisement server 120. In another example, one of such numbers may be the phone number for a major national bank's customer care operations, which is associated with a customer care application residing in application server 122. In another example, one of such numbers may be the phone number for a pizza restaurant that is associated with a user review webpage on Yelp.com 124, a Facebook page 126, a Flickr page 128 or another website 130.

Identification server 118 may additionally be configured to provide media in the same manner as advertisement server 120, application server 122 or any of the data sources 124-130.

In an embodiment, the identification server 118 receives inputted addresses from telecommunications device 102 as such addresses are being inputted or immediately after they are inputted. In such embodiments, identification server 118 maps the inputted addresses to addresses associated with media, determines information sufficient to enable the media to be accessed from one of the servers and websites 120-130, and provides the determined information to the telecommunication device 102. In other embodiments, the identification server 118 may request or instruct one of the servers and websites 120-130 to provide the media associated with the input address to the telecommunication device 102.

In further embodiments, the identification server 118 may simply store identification information associated with addresses and not include any mappings of addresses to media. In such embodiments, the identification server 118 receives the inputted addresses as they are input or after they are input, determines identification information associated with the inputted addresses, and provides the identification information to the telecommunication device 102. Such identification information may include any one or more of names, locations, addresses and categories. The identification server 118 may also provide the identification information and an indication of the telecommunication device 102 that requested it to advertisement server 120, application server 122, or website 124-130, enabling quicker provisioning of media, such as advertisements and/or coupons, to the telecommunication device 102.

In yet further embodiments, the identification server 118 may provide both information sufficient to access media and identification information to the telecommunication device 102.

In various embodiments, advertisement server 120 may receive information associated with an inputted address, such as names, locations, addresses or categories, from the telecommunication device 102 or identification server 118. In response to receiving the information, advertisement server 120 determines media, such as advertisements and/or coupons, to provide to the telecommunication device 102. In some embodiments, the media may be determined in a manner analogous to keyword bidding on a search engine or advertisement provisioning on a social network. Upon determining the media, the advertisement server 120 provides the advertisements and/or coupons to the telecommunication device 102.

The telecommunication device 102 may also communicate directly or indirectly with an advertisement server 120. Advertisement server 120 may be situated within or without a telecommunications carrier's network or it may be accessible via the Internet. Advertisement server 120 is communicative with telecommunications device 102 in any manner and provides, directly or indirectly, in real-time, periodically or randomly, and either on a push or pull basis, media, such as advertisements or coupons, to telecommunications device 102. The advertisement server 120 may provide such media in response to receiving, from the telecommunication device 102, the information sufficient to access the media.

Advertisement server 120 may also be communicative with identification server 118. In an embodiment, advertisement server 120 may be communicative with identification server 120 in any manner and may provide, directly or indirectly, in real-time, periodically or randomly, and either on a push or pull basis, information sufficient for identification server 118 to associate an address with media, such as advertising, coupons or similar media that resides on advertisement server 120. Advertisement server 120 may additionally provide other data that may be utilized by identification server 118, such as geographical information, map information, hours of operation relating to the proprietors subject of advertisements, and other information that may be used by identification server 118. Further, in response to a request or instructions from the identification server 118, the advertisement server 120 may provide media to the telecommunication device 102.

Telecommunications device 102 may also communicate with an application server 122. Application server 122 may be one or more servers, either integrated into a telecommunications carrier network or accessible via the Internet. In an embodiment, application server 122 may be an “app store” such as the Apple® AppStore or Google® Play. Application server 122 is communicative with telecommunications device 102 in any manner and may provide, in real-time, periodically or randomly, and either on a push or pull basis, downloadable applications or media associated with downloadable applications that may be executed on telecommunications device 102.

The application server 122 may provide the applications or media to the telecommunication device 102 responsive to receiving, from the telecommunication device, information sufficient to access the applications or media, or responsive to receiving, from the identification server 118, a request or instructions to provide the applications or media to the telecommunication device 102. Also or instead, the application server 122 may receive, from the telecommunication device 102 or identification server 118, identification information associated with an inputted address, such as names, locations, addresses or categories. In response to receiving the identification information, application server 122 determines applications or media to provide to the telecommunication device 102, the applications or media being associated with the identification information. In some embodiments, the applications or media may be determined in a manner analogous to keyword bidding on a search engine or advertisement provisioning on a social network. Upon determining the applications or media, the application server 122 provides the applications or media to the telecommunication device 102

Application server 122 may also be communicative with identification server 118 in any manner and may provide, in real-time, periodically or randomly, and either on a push or pull basis, information sufficient for identification server 118 to associate addresses with applications available on application server 122.

Telecommunications device 102 may also communicate with any number of additional data sources, such as websites 124-130. For example, telecommunications device 102 may be communicative with servers hosting or associated with websites, such as a commercial review website such as Yelp.com 124, a social networking website such as Facebook.com 126, a photo management and sharing website such as Flickr.com 128, or other websites 130. Data sources, such as websites 124-130, may be communicative with telecommunications device 102 in any manner and may provide, in real-time, periodically or randomly, and either on a push or pull basis, data that may be presented on telecommunications device 102. Data sources, such as websites 124-130, may also be communicative with identification server 118 in any manner and may provide, in real-time, periodically or randomly, and either on a push or pull basis, information sufficient for identification server 118 to associate addresses with data residing in data sources, such as websites 124-130.

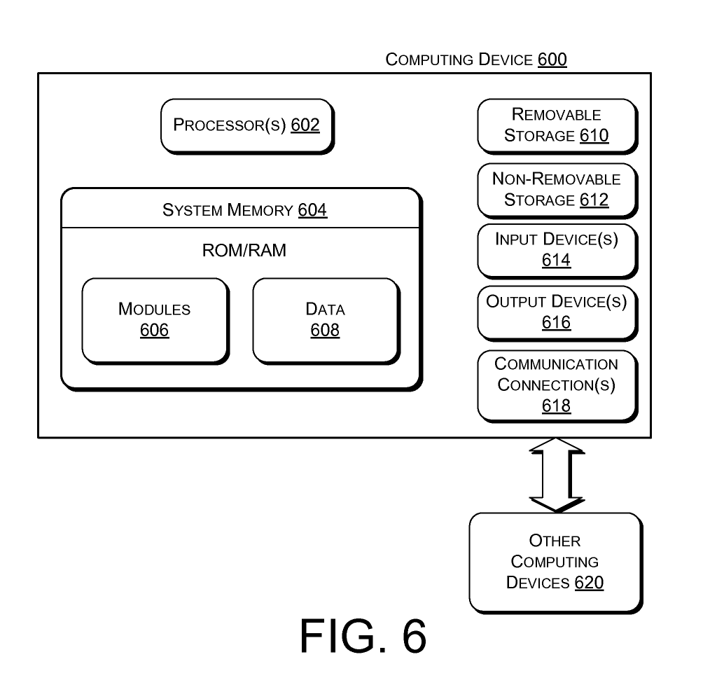

Telecommunication device 102, identification server 118, advertisement server 120, application server 122 and data sources, such as websites 124-130, may each be or include any sort of computing device, such as a smart phone, a cellular phone, a personal digital assistant (PDA), a personal computer (PC), a laptop, a desktop, a workstation, a server, a cloud computing environment, a media player, a gaming device, a television, a media center, or the like. Example computing devices are illustrated in greater detail in FIG. 6 and are described in detail below with reference to that figure.

The telecommunication device 102, identification server 118, advertisement server 120, application server 122, and data sources, such as websites 124-130, may also be connected by one or more networks. Such networks may be or include a telecommunication network providing telecommunication services to the telecommunication device 102 and to a plurality of other devices of other users. The network may also be or include a public or private packet switched network, such as the Internet, circuit switched network, or combination of packet switched and circuit switched networks. The network may include a plurality of computing devices connected, for example, by one or more wide area networks (WAN), one or more local area networks (LAN), and/or one or more personal area networks (PAN). Communication between these ones of these computing devices of the network may be wired, wireless, or both. These communications may utilize any sort of communication protocol known in the art for sending and receiving messages, such as the Transmission Control Protocol/Internet Protocol (TCP/IP), the Hypertext Transfer Protocol (HTTP), Extensible Messaging and Presence Protocol (XMPP), and/or the Session Initiation Protocol (SIP). Any one or more of these protocols may also be used to communicate with the telecommunication device 102 through base stations or other access points and to further communicate with one or more other networks.

### Example User Interfaces

FIG. 2A illustrates a touch screen display 202 of a telecommunications device 102. The touch screen display 202 is one type of display 116 and presents a display field 204 where the inputted numbers and other media may be presented to the user of telecommunications device 102, a keypad field 206 presenting touch screen keys or “soft” keys that a user of telecommunications device 102 may select in order to input data, and a “call” field 208 that a user may select to initiate a telephone call.

In FIG. 2B, the user of telecommunications device 102 has input the first six digits of the phone number 324-123-4567. In an embodiment, evaluation module 106 may wait until the full complement of ten digits has been inputted by the user to map the received phone number to a phone number or address that is stored in contact list 108, communications history 110 or identification store 114. In another embodiment, as shown in FIG. 2B, evaluation module 106 predicatively maps the inputted six digits to the stored phone numbers in contact list 108, communications history 110 and in identification store 114, which in this case generates two possible options that are displayed in predictive text fields 210A and 210B. The user of telecommunications device 102 may stop typing the digits of phone number 324-123-4567 and simply touch predictive text field 210A to complete data entry.

In FIG. 2C, the user of telecommunications device 102 has successfully inputted the number 324-123-4567 which, in this figure, is the phone number for “Sam's Pizza”. Competitors of Sam's Pizza, such as “YourTown Pizza” and “Mobile Pizza”, as shown in 214 and 216, respectively, of FIG. 2C, may want to offer competing offers or advertisements to the user of telecommunications device 102, in instances when the user of mobile telecommunications device 102 is inputting or has inputted the number for Sam's Pizza. In those instances, YourTown Pizza and Mobile Pizza may purchase advertising or coupon placements from a seller of such services, such as the wireless telecommunications carrier serving telecommunications device 102, an advertising agency operating identification server 118 and/or advertisement server 120, or another entity that operates identification server 118 or advertisement server 120. YourTown Pizza may want to not only advertise its services in this manner, but also provide a one-time coupon to the user of telecommunications device 102 that may induce such user to abandon his or her efforts to contact Sam's Pizza, and instead use the one-time coupon to purchase a pizza from YourTown Pizza. In those instances, the operator of identification server 118 will associate Sam's Pizza's phone number, 324-123-4567 with one or more advertisements or coupons on advertisement server 120, including the coupon for YourTown Pizza. In addition to such phone number, identification server 118 may associate other addresses associated with Sam's Pizza with one or more advertisements or coupons on advertisement server 120, such as an e-mail address, text messaging address, social networking handle, or other address for Sam's Pizza.

Identification server 118 will then provide the phone number 324-123-4567 and/or other addresses associated with Sam's Pizza to telecommunications device 102. As stated above, identification server 118 may provide such a phone number singly or with a group of other phone numbers and/or addresses, in real time or periodically. Identification server 118 may provide such numbers or addresses in advance of the user of telecommunications device 102 inputting the phone numbers or addresses. In another embodiment, dialer/addressing interface 104 or evaluation module 106 may poll identification server 118 in real time, during the inputting of the number or address or after the inputting of the number or address, to determine whether the inputted number or address is associated with an advertisement or coupon on advertisement server 120. In another embodiment, the advertisements or coupons are directly provided to telecommunications device 102 along with the numbers or addresses, such that they reside on telecommunications device 102 in a data store, such as identification store 114, until the user of telecommunications device 102 inputs the associated number or address.

In an embodiment, during or after the user of telecommunications device 102 inputs or has inputted the number or address, evaluation module 106 maps the inputted number or address to a number or address provided by identification server 118 and/or contact list 108. In FIG. 2C, evaluation module 106 maps the inputted number 324-123-4567 to the number of Sam's Pizza and then identifies that such number is associated with a coupon for $2.00 off any pizza at YourTown Pizza and an advertisement from Mobile Pizza. In an embodiment, if the coupon and advertisement have already been provided to telecommunications device 102 from either identification server 118 or advertising server 120, then telecommunications device 102 will present such coupon and advertisement on or via telecommunications device 102. In an embodiment, if the coupon and advertisement, or either of them, have not already been provided to telecommunications device 102, then telecommunications device 102 will poll one or both of advertisement server 120 and identification server 118, and the server that hosts such media will provide the media to telecommunications device 102. Such coupon or advertisement may be in any sensible form, such as a visual presentation, audio presentation, or any other presentation that may be sensed by the user of telecommunications device 102. In FIG. 2C, the coupon for YourTown Pizza is presented on the touch screen display 202 in field 214, and the advertisement for Mobile Pizza is presented in field 216. Thus, the user of telecommunications device 102 may elect to access the coupon or advertisement by simply touching on the relevant field 214 or 216.

In FIG. 2D, the user of telecommunications device 102 has successfully inputted the number 324-123-4567 which, in this figure, is the phone number for “Sam's Pizza”. The user of telecommunications device 102 may desire to receive information about an inputted address in advance of initiating or sending a communication to that address. For example, the user may wish to see customer reviews of a restaurant in advance placing a telephone call to the restaurant, such as customer reviews posted on Yelp.com. Proprietors of information services may want to make their media available to users of telecommunications devices, such as telecommunications device 102, in instances where such users are actively dialing a phone or otherwise addressing communications to restaurants and other establishments that are the subject of such media. Such proprietors may therefore contract with the operator of identification server 118 to associate addresses with the proprietor's media that is related to such addresses. In FIG. 2D, the proprietor of Yelp.com 124, a well-known restaurant and consumer services review site, may wish to provide “instant reviews” to users of telecommunications devices such as telecommunications device 102. Thus, identification server 118 may associate such phone numbers and addresses for, for example, Sam's Pizza, with media that is available on Yelp.com. For example, the phone number 324-123-4567 may be associated with a Yelp.com URL that is associated with media specific to Sam's Pizza. Identification server 118 provides the phone number 324-123-4567 to telecommunications device 102, and such phone number is stored in identification store 114. In another embodiment, evaluation module may poll identification server 118 in real time and, if the phone number 324-123-4567 is associated with media in identification server 118, then identification server 118 will return information sufficient for telecommunications device 102 to obtain the media. In FIG. 2D, phone number 324-123-4567 is shown in inputted address field 212, and telecommunications device 102 presents the Yelp.com media from Yelp.com 124 in display field 218, which includes, in this example, user comments 220 and 222.

In FIG. 2E, the user of telecommunications device 102 has successfully inputted the number 324-123-4567 which, in this figure, is the phone number for a personal contact, “John Doe”. The user of telecommunications device 102 may desire to receive the latest updates regarding his or her personal contacts during or after addressing a communication to such contacts. For example, the user of telecommunications device 102 may have multiple contacts who participate in social networking sites, such as Facebook.com 126, Flickr.com 128, or other websites 130 offering shared information, such as contacts' geographic location. In an embodiment, dialer/addressing interface 104 or evaluation module 106 may be enabled to associate the numbers and/or addresses of contacts in contact list 108 with contacts in the user's Facebook.com, Twitter, Flickr or similar accounts or subscriptions. In an embodiment, the user of telecommunications device 102 may have previously provided user name and login information sufficient for dialer/addressing interface 104 and/or evaluation module 106 to access such accounts and to poll such accounts for updates, without having to utilize either of identification server 118 or advertising server 120. In FIG. 2E, the user of telecommunication's device has a contact “John Doe” in his or her contact list 108, and such contact list may include such contact's phone number, e-mail address, social networking handles or addresses on Facebook.com 126, Flickr.com 128 or other websites or services 130. In an embodiment, evaluation module 106 evaluates phone number 324-123-4567 during or after input of such number and maps such number to one or more addresses in contact list 108. When the number is mapped to a phone number 324-123-4567, telecommunications device 102 may then poll a relevant media source, such as Facebook.com 126, Flickr.com 128 or other website or source 130 and receive media relevant to the contact “John Doe”. As shown in FIG. 2E, relevant media consisting of a Facebook update is presented in display field 226, a Twitter update is presented in display field 228, a Flickr.com update, consisting of digital photographic image 232, is presented in display field 230, and location information showing John Doe's geographic location is presented in display field 234, including a map 236.

In FIG. 2F, the user of telecommunications device 102 has successfully inputted the number 324-123-4567 which, in this figure, is the phone number for a bank, “Americas Bank.” The user of telecommunications device 102 may desire to receive an update regarding how to most efficiently receive information regarding his or her bank accounts and other financial information. Similarly, a commercial enterprise may desire to avoid the operating costs of communicating with its customers and prospective customers by telephone and, instead, offer other communications options that are more efficient and of lower cost to the enterprise. In FIG. 2F, “Americas Bank” desires to offer the user of telecommunications device 102 with a lower-cost and more efficient communications option, namely, a mobile website “M.AMERICASBANK.COM”, at which the user may obtain the information he or she is seeking without having to engage a live customer care representative in a telephone communication. In an embodiment, a party receiving communications of any kind may engage the operator of identification server 118 to associate the phone number 324-123-4567 with one or more “hotlinks”, such as M.AMERICASBANK.COM, such that such link is presented to the user of telecommunications device 102 during or after the inputting of such number. The operator of identification server 118 associates such number and such link and, as previously described, provides the number to telecommunications device 102 for storage in identification store 114. As previously described, the number may be provided in real time or periodically, with or without additional information such as the link M.AMERICASBANK.COM. When the user of telecommunications device 102 inputs the number 324-123-4567, or after inputting such number, evaluation module 106 polls identification store 114 and maps the inputted number to the number stored therein. In an embodiment, telecommunications device 102 then polls identification server 118 or another server, such as advertisement server 120 or application server 122, providing the inputted number. Advertisement server 120 or application server 122 then provides media, including at least the link M.AMERICASBANK.COM 240, to telecommunications device 102 for display in display field 238. In an embodiment, such media may have been previously provided to telecommunications device 102 for storage in identification store 114, and telecommunications device 102 thus displays the stored media without polling of an external data stores.

In FIG. 2G, the user of telecommunications device 102 has successfully inputted the number 324-123-4567 which, in this figure, is again the phone number for a bank, “Americas Bank.” As mentioned with respect to FIG. 2F, the user of telecommunications device 102 may desire to receive updates regarding how to most efficiently receive information regarding his or her bank accounts and other financial information. Again, a commercial enterprise may desire to avoid the operating costs of communicating with its customers and prospective customers by telephone and, instead, offer other communications options that are more efficient and of lower cost to the enterprise. In FIG. 2G, “Americas Bank” desires to offer the user of telecommunications device 102 with a lower-cost and more efficient communications option, namely, a downloadable application which, if downloaded and launched by the user on telecommunications device 102, provides the user with an efficient option to obtain the information he or she is seeking without having to engage a live customer care representative in a telephone communication. In an embodiment, a party receiving communications of any kind may engage the operator of identification server 118 to associate the phone number 324-123-4567 with one or more applications that are available via an applications server 122, such as the Apple® AppStore or Google® Play. The operator of identification server 118 associates such number with the application(s) and, as previously described, provides the number to telecommunications device 102 for storage in identification store 114. As previously described, the number may be provided in real time or periodically, with or without additional information. When the user of telecommunications device 102 inputs the number 324-123-4567, or after inputting such number, evaluation module 106 polls identification store 114 and maps the inputted number to the number stored therein. In an embodiment, telecommunications device 102 then polls identification server 118 or another server, such as application server 122. Application server 122 then offers download of, or begins to transmit to telecommunications device 102, one or more applications that are associated with number 324-123-4567. In an embodiment, such application may be already preloaded on telecommunications device 102 or may have been previously provided to telecommunications device 102, and telecommunications device 102 thus launches the applications without polling of an external data stores.

In FIG. 2H, the user of telecommunications device 102 has successfully inputted the number 324-123-4567 which, in this figure, is the phone number for an investment management firm, “YourInvestments.” The user of telecommunications device 102 may desire to receive updates regarding how to most efficiently receive information regarding investments, such as daily stock quotes. Similarly, a commercial enterprise may desire to avoid the operating costs of communicating with its customers and prospective customers by telephone and, instead, offer other communications options that are more efficient and of lower cost to the enterprise. In FIG. 2H, “YourInvestments” desires to offer the user of telecommunications device 102 with a lower-cost and more efficient communications option, namely, daily delivery of stock quotes of interest to the user of telecommunications device 102 via SMS or “text” messages. In an embodiment, a party receiving communications of any kind may engage the operator of identification server 118 to associate the phone number 324-123-4567 with a subscription service, such as a subscription for daily stock quotes via SMS, such that a subscription offer is presented to the user of telecommunications device 102 during or after the inputting of such number. The operator of identification server 118 associates such number and such media and, as previously described, provides the number to telecommunications device 102 for storage in identification store 114. As previously described, the number may be provided in real time or periodically, with or without additional information such the media consisting of an offer to provide daily stock quotes via SMS. When the user of telecommunications device inputs the number 324-123-4567, or after inputting such number, evaluation module 106 polls identification store 114 and maps the inputted number to the number stored therein. In an embodiment, telecommunications device 102 then polls identification server 118 or another server, such as advertisement server 120 or other server 130, providing the inputted number. Advertisement server 120 or other server 130 then provides media, such as the media appearing in display field 246, which may include an interactive button 248 via which the user may elect to subscribe to the daily SMS messages, to telecommunications device 102. In an embodiment, such media may have been previously provided to telecommunications device 102 for storage in identification store 114, and telecommunications device 102 thus displays the stored media without polling of an external data stores.

### Example Operations

FIG. 3 illustrates a flowchart showing an example method of determining media associated with an inputted address based at least in part on information associated with that address stored on the telecommunication device and of displaying that media, in accordance with various embodiments.

At block 302, telecommunications device 102 receives data from identification server 118. Such data consists at least of one or more phone numbers or other addresses, such as e-mail addresses, text messaging addresses, social networking handles, etc., and may also include other information such as addresses of the servers hosting media that is associated with such numbers and addresses. Telecommunications device 102, after receiving such data, stores such data in identification store 114 or other data stores. Alternatively, at block 302, information may be added to a contact list 108 or communication history 110 as a result of user activity. Such information may be associated with a phone number or other address.

At block 304, the user of a telecommunication device 102 dials a phone number or inputs an address into telecommunications device 102. Dialing or inputting may be accomplished through any dialing or inputting method, such as by selecting alphanumeric keys, audibly speaking the number or address into a speech recognition interface, or selecting representations of phone numbers or addresses stored in a contact list 108.

At block 306, evaluation module 106 evaluates all or part of the inputted number or address and determines whether the number or address maps to a number or address associated with a contact in contact list 108, to information included in communication history 110, to a record in identification store 114, or to rules or criteria (e.g., a rule or criterion for numbers with the prefix “800” in place of the area code which associates the category “business” with such numbers).

At block 308, in response to determining that the dialed number or inputted address maps to a number or address stored in contact list 108, communication history 110, identification store 114, or rules/criteria, the telecommunication device 102 provides information associated with the dialed number or inputted address to an advertisement server 120, an application server 122, or one or more of various cloud sources, such as Yelp.com 124, Facebook 126, Flickr 128 or other websites 130. The information may include any of the dialed number or inputted address, information sufficient to access media, or other identification information (e.g., a category or location associated with the number/address).

At block 310, telecommunication device 102 receives media from advertisement server 120, application server 122, or a web-based source such as any of sources 124-130. Such media may consist of any type of media, such as an advertisement and/or coupon from the advertisement server 120, a downloadable application or media associated with a downloadable application from application server 122, or other information or media from any other server such as web sources 124-130.

At block 312, telecommunication device 102 presents the received media in any manner, such as visually, audibly, etc. In some embodiments, the media may be displayed as part of a dialer/addressing user interface 104 while the number or address is being inputted, after the number or address has been inputted, and/or during or after a communication resulting from the number dialing or address inputting.

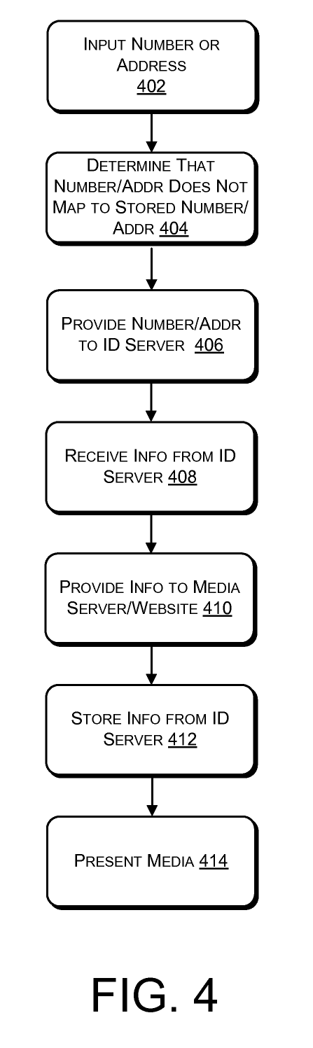

FIG. 4 illustrates a flowchart showing an example method of determining media associated with an inputted address based at least in part on information associated with that address, that information being retrieved from a remote identification server, and of displaying that media, in accordance with various embodiments.

At block 402, the user of a telecommunication device 102 inputs a number or address into telecommunications device 102. Inputting may be accomplished through any dialing or inputting method, such as by selecting alphanumeric keys, audibly speaking the number or address into a speech recognition interface, or selecting representations of phone numbers or addresses stored in a contact list 108.

At block 404, evaluation module 106 evaluates all or part of the inputted number or address and determines whether the number or address maps to a number or address associated with a record in identification store 114, a contact in contact list 108, or a record in communications history 110.

At block 406, in response to determining that the inputted number or address does not match a number or address associated with a contact in contact list 108, a record in identification store 114, a number or address in the communication history 110, or a number associated with rules or settings, the telecommunication device provides the inputted number or address to identification server 118.

At block 408, telecommunication device 102 receives identification information from identification server 118, such as a number or address, which maps to the inputted number or address and is associated with a name, location, category, or with information sufficient to enable the telecommunication device 102 to access media from one of servers and websites 120-130. In an embodiment, telecommunications device 102 may receive, concurrently or subsequently to receiving the information from identification server 118, media from one or more other servers, such as advertisements and/or coupons from advertisement server 120, applications or media relating to applications from application server 122, or other data or information from sources 124-130. In an embodiment, such other servers and websites 120-130 may receive the identification information and an identifier or address associated with telecommunications device 102 directly from identification server 118, enabling such other servers and websites 120-130 to provide the media directly to telecommunications device 102 without waiting to receive the identification information from telecommunication device 102.

At block 410, if media has not been received from one of the servers and websites 120-130 in the manner described above, the evaluation module 106 provides the information received from the identification server 118 to a relevant server, such as advertisement server 120, application server 122 or other sources 124-130.

At block 412, the telecommunication device 102 stores the identification information in identification store 114. The identification information may be stored in association with a contact list 108 or communications history 110. Although presented subsequent to block 410, it will be understood that storage of the received information may occur before, concurrent or after the evaluation of the information by evaluation module 106.

At block 414, telecommunications device 102 receives media from a server, such as advertisement server 120, application server 122 or sources 124-130, and then presents the received media. In some embodiments, the media may be displayed as part of a dialer/addressing user interface during and/or after the communication resulting from the inputting of the number or address. The presenting may occur prior to, concurrently with, or subsequent to the storing.

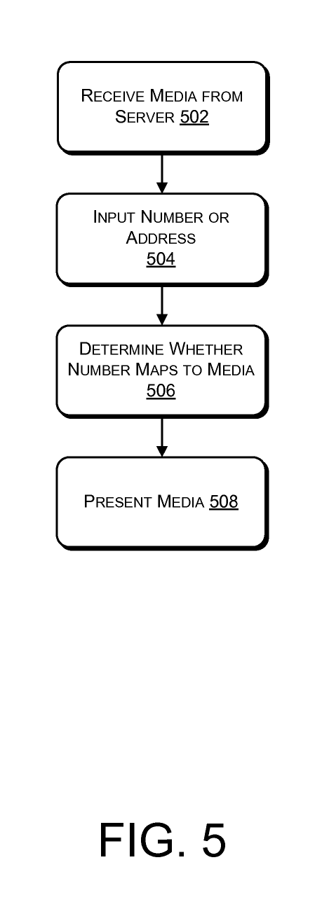

FIG. 5 illustrates a flowchart showing an example method of presenting pre-loaded media associated with an inputted number or address, in accordance with various embodiments.

At block 502, telecommunications device 102 receives data from identification server 118 and/or another server, such as advertisement server 120, application server 122 or other sources 124-130. Such data includes at least of one or more phone numbers or other addresses, such as e-mail addresses, text messaging addresses, social networking handles, etc., and includes media associated with such numbers or addresses. Telecommunications device 102, after receiving such data, stores at least the numbers or addresses and media in identification store 114 or other data stores. Such numbers, addresses and media may be provided in real time or periodically, and may be provided in response to a change in location of telecommunications device 102. For example, if telecommunications device 102 receives periodic media from an advertisement server 120, such as GroupOn™, it may receive a new set of media from advertisement server 120 upon being powered on in a new geographic location. The selection of media may be based on a variety of factors, such as a communication history, a browsing history, a social network profile, or any other source of descriptions available about the user of telecommunications device 102. In one embodiment, the user of telecommunications device 102 may register with the advertisement/coupon service, indicating advertisements and/or coupons that the user is interested in.

At block 504, the user of telecommunication device 102 inputs a number or address into telecommunications device 102. As mentioned above, such inputting may be accomplished in any manner, such as by selecting alphanumeric keys, speaking into a speech recognition interface, or selecting representations of numbers or addresses stored in a contact list 108 or communication history 110.

At block 506, evaluation module 106 maps the inputted number or address to numbers or addresses stored in identification store 114. The media may be associated with metadata that includes specific phone numbers, zip codes, or other information (e.g., the names, categories, and locations described above with respect to FIG. 3), and telecommunication device 102 maps the inputted number or address and/or associated information retrieved from a communication history 110 or contact list 108 to the metadata associated with the media.

At block 508, telecommunication device 102 presents the media. In some embodiments, the media may be presented as part of a dialer/addressing user interface 104 during and/or after the communication resulting from the inputting of the number or address. If multiple items of media correspond to the mapping, telecommunications device 102 may select one or more items of media at random, may use priorities provided with the media to select the presented media, or may select media based on the user's communication history, browsing history, social network profile, or any other available source of information about user preferences.

### Example Systems

FIG. 6 illustrates an example computing device system architecture, such as a system architecture of the telecommunication device 102, a system architecture of the identification server 118, a system architecture of the advertisement server 120, a system architecture of a device of the application server 122, or a system architecture of a device of any of sources 124-130, in accordance with various embodiments. As illustrated, the computing device 600 includes processor(s) 602, a system memory 604 storing modules 606 and data 608, a removable storage 610, a non-removable storage 612, input device(s) 614, output device(s) 616, and communication connections 618 for communicating with other computing devices 620.

In some embodiments, the processor(s) 602 is a central processing unit (CPU), a graphics processing unit (GPU), or both CPU and GPU, or other processing unit or component known in the art.

In various embodiments, system memory 604 is volatile (such as RAM), non-volatile (such as ROM, flash memory, etc.) or some combination of the two. Example system memory 604 may include one or more of RAM, ROM, EEPROM, a Flash Memory, a miniature hard drive, a memory card, an optical storage, a magnetic cassette, a magnetic tape, a magnetic disk storage or another magnetic storage device, or any other medium.

As previously mentioned, the system memory 604 stores modules 606 and data 608. These modules 606 and data 608 may comprise any one or more modules, applications, processes, threads, classes, algorithms, data structures, files, and/or databases, such as the modules, applications, processes, threads, classes, algorithms, data structures, files, and/or databases utilized in performing the operations described above, some part of which are illustrated in FIGS. 3-5.

The computing device 600 includes data storage devices (removable and/or non-removable) in addition to the system memory 604, such as, for example, magnetic disks, optical disks, or tape. Such additional storage is illustrated in FIG. 6 by removable storage 610 and non-removable storage 612. Computer storage media may include volatile and nonvolatile, removable and non-removable media implemented in any method or technology for storage of information, such as computer readable instructions, data structures, program modules, or other data. System memory 604, removable storage 610, and non-removable storage 612 are all examples of computer-readable storage media. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 600. Any such computer-readable storage media may be part of the computing device 600.

In various embodiment, any or all of system memory 604, removable storage 610, and non-removable storage 612 store programming instructions which, when executed, implement some or all of the above-described operations of the computing device 600.

The computing device 600 also has input device(s) 614, such as a keyboard, a mouse, a touch-sensitive display, voice input device, etc., and output device(s) 616 such as a display, speakers, a printer, etc. These devices are well known in the art and need not be discussed at length here.

The computing device 600 also contains communication connections 618 that allow the computing device 600 to communicate with other computing devices 620.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

We claim:

1. A method comprising:
receiving, by a telecommunication device, a number or address inputted using one or more input devices associated with the telecommunication device;
providing, by the telecommunication device, the inputted number or address or information associated with the inputted number or address to a media server; and
presenting, by the telecommunication device, the media in association with a presentation of the inputted number or address.

2. The method of claim 1, wherein receiving the inputted number or address comprises suggesting candidate numbers or addresses for selection while the number or address is being inputted.

3. The method of claim 1, further comprising determining that inputted number or address maps to a number or address stored in a contact list, a communications history, or an identification store of the telecommunication device.

4. The method of claim 3, further comprising retrieve the information associated with the inputted number or address from the contact list, the communications history, or the identification store.

5. The method of claim 1, further comprising updating an identification store of the telecommunication device with numbers, addresses, and information received from a remote identification server.

6. The method of claim 1, further comprising providing the inputted number or address to a remote identification server and, in response, receiving the information associated with the inputted number or address from the remote identification server.

7. The method of claim 1, wherein the inputted number or address is one of a phone number, an e-mail address, a text messaging address, a social networking handle, or an instant messaging handle and the information associated with the inputted number or address includes one or more of a name, a physical address, a location, or a category.

8. The method of claim 1, wherein the media server is one of an advertisement server, an application server, or a web server.

9. The method of claim 1, wherein the media includes any of an advertisement, a coupon, an application, an option to launch or download an application, a web page, a review, an online forum, social network content, microblog content, photos, or maps.

10. The method of claim 1, wherein the presenting of the media in association with the presentation of the inputted number or address comprises concurrently displaying the media and the inputted number or address.

11. The method of claim 1, further comprising performing the presenting of the media while the number or address is being input.

12. The method of claim 1, wherein the presenting includes displaying the media, playing the media as audio, or, when the media is an application, launching the application.

13. The method of claim 1, wherein the presenting is performed in place of initiating a communication associated with the inputted number or address.

14. One or more computer storage devices having stored thereon a plurality of executable instructions configured to program a telecommunication device to perform operations comprising:
receiving a number or address inputted using one or more input devices associated with the telecommunication device;
providing the inputted number or address to an identification server;
in response to providing the inputted number or address, receiving, from the identification server or from a media server, media that is associated with the inputted number or address by the identification server or by the media server; and
presenting the media in association with a presentation of the inputted number or address.

15. The one or more computer storage media of claim 14, wherein the identification server requests or instructs the media server to provide the media to the telecommunication device.

16. The one or more computer storage media of claim 14, wherein the providing is performed in response to determining that there is no mapping between the inputted number or address and numbers or addresses included in a contact list, a communications history, or an identification store of the telecommunication device.

17. A telecommunication device comprising:
a processor;
one or more input devices;
one or more output devices;
one or more media and associated metadata;
a dialer or addressing interface configured to be operated by the processor to receive, from the one or more input devices, alphanumeric characters forming the inputted number or address; and
an evaluation module configured to be operated by the processor to:
map the inputted number or address or information associated with the inputted number or address to the metadata associated with the one or more media,
select media based on the mapping, and
cause the one or more output devices to present the selected media in association with a presentation of an inputted number or address.

18. The telecommunication device of claim 17, wherein a touch-sensitive display of the telecommunication device is both one of the one or more input devices and one of the one or more output devices.

19. The telecommunication device of claim 17, wherein the one or more media are received periodically or responsive to a change in a location of the telecommunication device.

20. The telecommunication device of claim 17, wherein the evaluation module is further configured to, when multiple media map to the inputted number or address, select the media based on a communications history, a browsing history, a social network profile, or user preferences.

21. The telecommunication device of claim 17, wherein the mapping includes retrieving information associated with the inputted number or address and mapping the retrieved information to the metadata associated with the one or more media.
